(19) United States
(12) Patent Application Publication
(10) Pub. No.: US 2010/0119686 A1
(43) Pub. Date: May 13, 2010

(54) FOOD CONDIMENT

(76) Inventor: Ellen May, Tulsa, OK (US)

Correspondence Address: L.C. BEGIN & ASSOCIATES, PLLC, 510 HIGHLAND AVENUE, PMB 403, MILFORD, MI, 48381, US

(21) Appl. No.: 12/608,540

(22) Filed: Oct. 29, 2009

Related U.S. Application Data
(60) Provisional application No. 61/113,339, filed on Nov. 11, 2008.

(51) Int. Cl. A23L 1/22; A23D 7/005; A23L 1/225; A23L 1/223; A23L 1/24; A23L 1/09

(52) U.S. Cl. 426/605; 426/650; 426/519

(57) ABSTRACT

One embodiment of a food condiment may include yellow mustard, a salad dressing, sour cream, clover honey, dark amber maple syrup, light brown sugar and spiced rum. The yellow mustard, the salad dressing and the sour cream may be mixed to form a first interim mixture. Further, the clover honey, the dark amber maple syrup, and the light brown sugar may be added to and mixed with the first interim mixture, to form a second interim mixture. The spiced rum may also be added to and mixed with the second interim mixture to form the food condiment. Further, disclosed is a method for preparing the food condiment.

### CROSS REFERENCE TO RELATED APPLICATION

This application claims the benefit of U.S. Provisional Application No. 61/113,339 filed on Nov. 11, 2008 the disclosure of which is incorporated by reference.

### FIELD OF THE DISCLOSURE

The present disclosure generally relates to food condiments, and more particularly, to a mustard-based food condiment that is a blend of natural and healthy ingredients.

### BACKGROUND OF THE DISCLOSURE

Various food condiments, such as mustard-based condiments, are used as dipping sauces, salad dressings, marinades and the like. In addition to traditional techniques of preparing mustard-based condiments, various processing techniques have been devised to prepare mustard-based condiments for targeting consumers who want to add flavor to their food. Most mustard-based condiments may also include preservatives for prolonging shelf lives thereof. However, excessive consumption of these preservatives may be somewhat unhealthy. Further, many mustard-based condiments are prepared using artificial ingredients that are deemed to be healthy but fail to have a taste similar to traditional condiments.

As described above, most of the mustard-based condiments may either include unhealthy ingredients that provide a good taste and/or act as preservatives, or may include healthy but tasteless ingredients. Further, it has been observed that various mustard-based condiments that are available for being used to complement a food item may overpower an original taste of the food item.

### SUMMARY OF THE DISCLOSURE

One embodiment of a food condiment may include yellow mustard, salad dressing, sour cream, clover honey, dark amber maple syrup, light brown sugar and spiced rum. The clover honey, the dark amber maple syrup, and the light brown sugar are added to and mixed with a first interim mixture of the yellow mustard, the salad dressing and the sour cream, to form a second interim mixture. Further, the spiced rum is added to and mixed with the second interim mixture to form the food condiment.

Another embodiment of a food condiment may include about one cup of yellow mustard, about two and one-third cups of a salad dressing, about one-fourth cup of sour cream, about one-third cup of clover honey, about one-eighth cup of dark amber maple syrup, about three tablespoons of light brown sugar, and about one and a half tablespoons of spiced rum. The clover honey, the dark amber maple syrup, and the light brown sugar are added to and mixed with a first interim mixture of the yellow mustard, the salad dressing and the sour cream, to form a second interim mixture. Further, the spiced rum is added to and mixed with the second interim mixture to form the food condiment.

A method for preparing a food condiment may include mixing about one cup of yellow mustard, about two one-third cups of a salad dressing, and about one-fourth cup of sour cream to form a first interim mixture. The method may further include adding about one-third cup of clover honey, about one-eighth cup of dark amber maple syrup, and about three tablespoons of light brown sugar to the first interim mixture. Furthermore, the method may include mixing the clover honey, the dark amber maple syrup, and the brown sugar with the first interim mixture until the light brown sugar dissolves, to form a second interim mixture. Moreover, the method may include adding about one and a half tablespoons of spiced rum to the second interim mixture. In addition, the method may include mixing the spiced rum and the second interim mixture for about two minutes to form the food condiment.

### BRIEF DESCRIPTION OF THE DRAWINGS

These and other features and advantages of the present disclosure will be apparent from the following detailed description of preferred embodiments and best mode, appended claims, and accompanying drawings in which:

FIG. 1 is a perspective view of one embodiment of a food condiment packaged in a container;

FIG. 2 is a flow chart illustrating one embodiment of a method for preparing the food condiment of FIG. 1;

FIG. 3 is a flow chart illustrating another embodiment of a method for preparing a food condiment; and

FIG. 4 is a flow chart illustrating yet another embodiment of a method for preparing a food condiment.

Like reference numerals refer to like parts throughout the description of the drawings.

### DETAILED DESCRIPTION OF THE DISCLOSURE

The exemplary embodiments described herein in detail for illustrative purposes are subject to many variations in structure and design. It should be emphasized, however, that the present disclosure is not limited to a particular food condiment, as shown and described. It is understood that various omissions and substitutions of equivalents are contemplated as circumstances may suggest or render expedient, but these are intended to cover the application or embodiment without departing from the spirit or scope of the claims of the present disclosure. Also, it is to be understood that the phraseology and terminology used herein are for the purpose of description and should not be regarded as limiting.

The use of “including,” “comprising,” or “having” and variations thereof herein is meant to encompass the items listed thereafter and equivalents thereof as well as additional items. Further, the term “first,” “second,” and the like, herein do not denote any order, elevation or importance, but rather are used to distinguish one element from another. Further, the terms, “a” and “an” herein do not denote a limitation of quantity, but rather denote the presence of at least one of the referenced item.

The present disclosure provides a food condiment that may be used as a dipping sauce, a salad dressing, a marinade, and the like, for complementing various foods, such as a sandwich.

The food condiment may include yellow mustard. Specifically, the food condiment may include about one cup of classic yellow mustard. In one form, one cup of the classic yellow mustard may be equal to about 8 ounces. Of course, the food condiment may include any other amount, such as two or more cups, of the classic yellow mustard as per a manufacturer's preference.

Further, the food condiment may include a salad dressing. Specifically, the food condiment may include about two and one-third cups of the salad dressing. The salad dressing may have the density of a spread or a whip. In one form, two and one-third cups of the salad dressing may be equal to about 21 ounces. Of course, the food condiment may include any other amount, such as two or more cups, of the salad dressing as per a manufacturer's preference.

Furthermore, the food condiment may include sour cream. Specifically, the food condiment may include about one-fourth cup of sour cream. The sour cream may be obtained by fermenting a regular cream using lactic acid bacteria. In one form, one-fourth cup of the sour cream may be equal to about 2 ounces. Of course, the food condiment may include any other amount, such as one-third cup, of the sour cream as per a manufacturer's preference.

In addition, the food condiment may include clover honey. Specifically, the food condiment may include about one-third cup of clover honey. The clover honey may either be in a pure form or in a raw form. In one form, one-third cup of the clover honey may be equal to about 3 ounces. Of course, the food condiment may include any other amount, such as one-fourth cup, of the clover honey as per a manufacturer's preference.

Moreover, the food condiment may include dark amber maple syrup. Specifically, the food condiment may include about one-eighth cup of dark amber maple syrup in a pure form. The dark amber maple syrup is known to be used as a sweetener. In one form, one-eighth cup of the dark amber maple syrup may be equal to about 1 ounce. Of course, the food condiment may include any other amount, such as one-sixth cup, of the dark amber maple syrup as per a manufacturer's preference.

Additionally, the food condiment may include light brown sugar. Specifically, the food condiment may include about three packed level tablespoons of light brown sugar. The light brown sugar may either be in a crystal form or a powdered form, to be used for the food condiment.

The food condiment may also include about one and a half tablespoons of spiced rum. The spiced rum may have a flavor of spices and/or caramel. Further, the spiced rum may have a color of caramel.

In one form, the food condiment may also include at least one spice for providing a particular flavor. For example, the food condiment may include Cajun spice for providing a Cajun flavor. Specifically, the food condiment may include about one tablespoon and one-fourth teaspoon of the Cajun spice. The Cajun spice may include about half tablespoon of sweet paprika, about two tablespoons of kosher salt, about two tablespoons of garlic powder, about one tablespoon of dried thyme, about two teaspoons of ground celery seeds, about two teaspoons of ground black pepper, and about two teaspoons of cayenne pepper.

Alternatively, the food condiment may include Jamaican spice for providing a Jamaican flavor. Specifically, the food condiment may include about one tablespoon and one teaspoon of the Jamaican spice. The Jamaican spice may include about one-fourth cup of packed brown sugar, about three tablespoons of kosher salt, about three tablespoons of ground coriander, about two tablespoons of ground ginger, about two tablespoons of garlic powder, about one tablespoon of ground allspice, about one tablespoon of ground black pepper, about two teaspoons of cayenne pepper, about two teaspoons of ground nutmeg, and about one and a half teaspoons of ground cinnamon.

Of course, the food condiment may include any other natural spice for providing a particular flavor. Further, the food condiment may also include a combination of the Cajun spice and the Jamaican spice, in addition to any other natural spice.

The food condiment of the present disclosure may be a golden yellow condiment that is composed of natural ingredients and/or spices. Further, the food condiment is free from any preservative. Moreover, the food condiment may have a pudding-like texture that may be used with various foods. The food condiment may be served with a spoon or may be poured on a food item, such as a sandwich. Alternatively, a portion of a food item may be dipped into the food condiment prior to consumption.

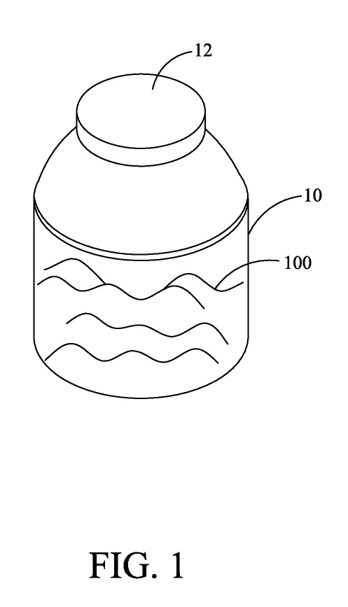

In addition, the food condiment may be packaged in a jar 10, as shown in FIG. 1, where the food condiment is represented as food condiment 100. The jar 10 may include a lid member 12 for closing the jar 10. The jar 10 may be stored at room temperature in a cool dry place. Predetermined amount of the food condiment 100 may be withdrawn from the jar 10 for consumption. The jar 10 may then again be refrigerated for preserving the remaining amount of the food condiment 100. The jar 10 may have a capacity of storing about eight ounces. Of the food condiment 100. Further, the jar 10 may have a height of about3½ inches (″) and a diameter of about 9½″.

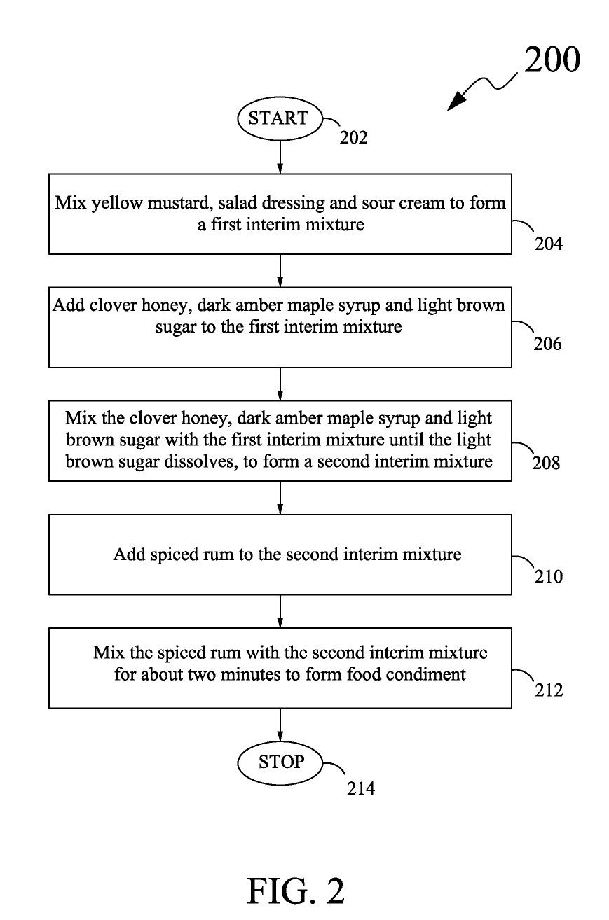

In another aspect, the present disclosure provides one embodiment of a method 200 for preparing the food condiment, as explained in conjunction with FIG. 2. The method 200 may start at 202. At 204, yellow mustard, a salad dressing, and sour cream may be mixed to form a first interim mixture. Specifically, about one cup of the yellow mustard, about two and one-third cups of the salad dressing, and about one-fourth cup of the sour cream may be mixed to form the first interim mixture. The yellow mustard, the salad dressing, and the sour cream may be mixed using a wire whisk in a large bowl until well blended.

At 206, clover honey, dark amber maple syrup and light brown sugar may be added to the first interim mixture in the bowl. Specifically, about one-third cup of the clover honey, about one-eighth cup of the dark amber maple syrup, and about three tablespoons of the light brown sugar may be added to the first interim mixture in the bowl. At 208, the clover honey, the dark amber maple syrup, and the brown sugar may be mixed with the first interim mixture until the light brown sugar dissolves, in order to form a second interim mixture.

At 210, spiced rum may be added to the second interim mixture. Specifically, about one and a half tablespoons of the spiced rum may be added to the second interim mixture. At 212, the spiced rum may be mixed with the second interim mixture for about two minutes to form the food condiment. The method may stop at 214.

The food condiment may then be filled in about four or more jars, such as the jar 10, having a capacity of about eight ounces The jars may then be closed and stored at room temperature in a cool dry place. Predetermined amount of the food condiment may be withdrawn from the jars for consumption. The jars may then be refrigerated for preserving the remaining amount of the food condiment.

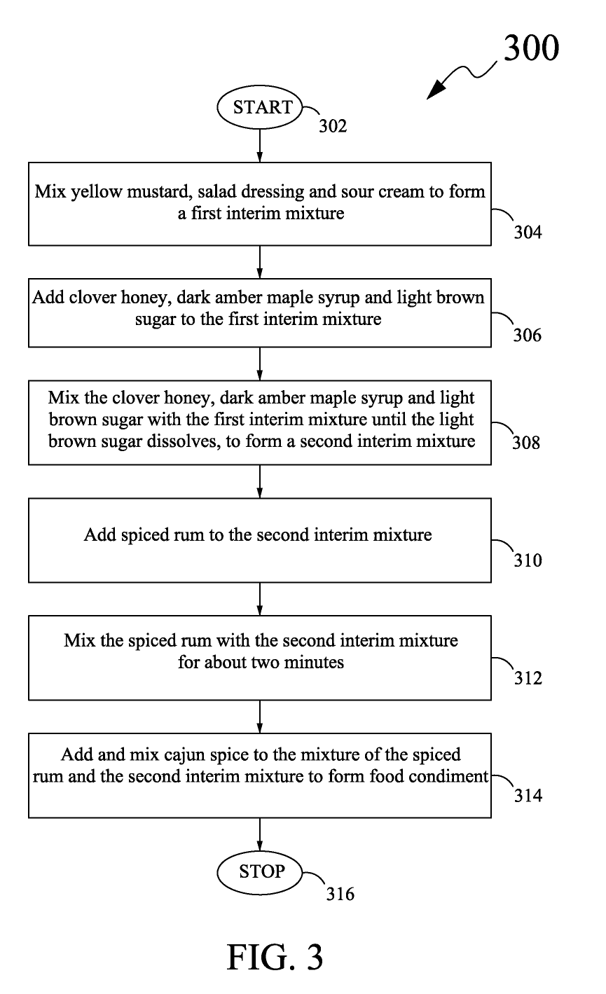

FIG. 3 is a flow chart illustrating another embodiment of a method 300 for preparing a food condiment of the present disclosure. The method 300 may be similar to the method 200. Specifically, the method 300 may start at 302. At 304, about one cup of yellow mustard, about two one-third cups of a salad dressing, and about one-fourth cup of sour cream may be mixed to form a first interim mixture. At 306, about one-third cup of clover honey, about one-eighth cup of dark amber maple syrup, and about three tablespoons of light brown sugar may be added to the first interim mixture. At 308, the clover honey, the dark amber maple syrup, and the brown sugar may be mixed with the first interim mixture until the light brown sugar dissolves, in order to form a second interim mixture. At 310, about one and a half tablespoons of spiced rum may be added to the second interim mixture. At 312, the spiced rum may be mixed with the second interim mixture for about two minutes.

At 314, about one tablespoon and one-fourth teaspoon of Cajun spice may be added to and mixed with the mixture of the spiced rum and the second interim mixture to form the food condiment of the present disclosure. The Cajun spice may be prepared by adding and mixing about half tablespoon of sweet paprika, about two tablespoons of kosher salt, about two tablespoons of garlic powder, about one tablespoon of dried thyme, about two teaspoons of ground celery seeds, about two teaspoons of ground black pepper, and about two teaspoons of cayenne pepper in a small bowl. The method may stop at 316.

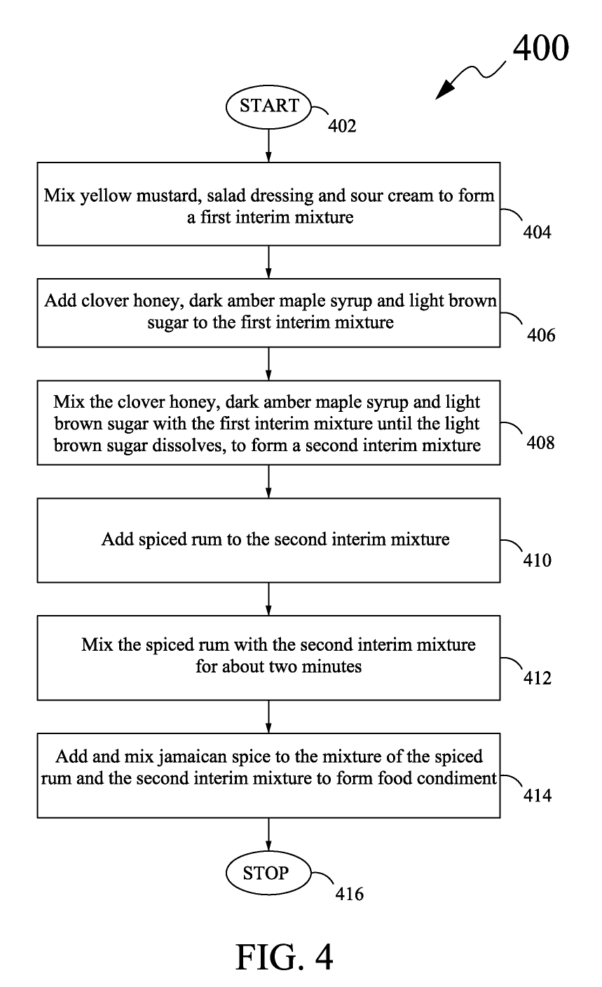

FIG. 4 is a flow chart illustrating yet another embodiment of a method 400 for preparing a food condiment of the present disclosure. The method 400 may be similar to the methods 200 and 300. Specifically, the method 400 may start at 402. At 404, about one cup of yellow mustard, about two one-third cups of a salad dressing, and about one-fourth cup of sour cream may be mixed to form a first interim mixture. At 406, about one-third cup of clover honey, about one-eighth cup of dark amber maple syrup, and about three tablespoons of light brown sugar may be added to the first interim mixture. At 408, the clover honey, the dark amber maple syrup, and the brown sugar may be mixed with the first interim mixture until the light brown sugar dissolves, in order to form a second interim mixture. At 410, about one and a half tablespoons of spiced rum may be added to the second interim mixture. At 412, the spiced rum may be mixed with the second interim mixture for about two minutes.

At 414, about one tablespoon and one teaspoon of Jamaican spice may be added to and mixed with the mixture of the spiced rum and the second interim mixture to form the food condiment of the present disclosure. The Jamaican spice may be prepared by adding and mixing about one-fourth cup of brown sugar, about three tablespoons of kosher salt, about three tablespoons of ground coriander, about two tablespoons of ground ginger, about two tablespoons of garlic powder, about one tablespoon of ground allspice, about one tablespoon of ground black pepper, about two teaspoons of cayenne pepper, about two teaspoons of ground nutmeg; and about one and a half teaspoons of ground cinnamon, in a small bowl. The method may stop at 416.

The present disclosure provides a food condiment that may be used as a dipping sauce, a dressing for foods such as salad, a marinade, and the like. The food condiment is free from preservatives and is prepared from natural ingredients and/or spices. Further, the food condiment may have a shelf life of about ten months. The food condiment serves as a flavorful condiment as an alternative to other mustard-based condiments that may either include unhealthy ingredients or may include tasteless ingredients. In addition, the food condiment may complement a food item without overpowering an original taste of the food item.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A food condiment comprising:
yellow mustard;
a salad dressing;
sour cream;
clover honey;
dark amber maple syrup;
light brown sugar; and
spiced rum,
wherein the yellow mustard, the salad dressing and the sour cream are mixed to form a first interim mixture, and wherein the clover honey, the dark amber maple syrup, and the light brown sugar are added to and mixed with the first interim mixture to form a second interim mixture, and wherein the spiced rum is added to and mixed with the second interim mixture to form the food condiment.

2. The food condiment of claim 1, further comprising at least one spice.

3. The food condiment of claim 2, wherein a spice of the at least one spice is Cajun spice.

4. The food condiment of claim 2, wherein a spice of the at least one spice is Jamaican spice.

5. A food condiment comprising:
about one cup of yellow mustard;
about two and one-third cups of a salad dressing;
about one-fourth cup of sour cream;
about one-third cup of clover honey;
about one-eighth cup of dark amber maple syrup;
about three tablespoons of light brown sugar; and
about one and a half tablespoons of spiced rum,
wherein the yellow mustard, the salad dressing and the sour cream are mixed to form a first interim mixture, and wherein the clover honey, the dark amber maple syrup and the light brown sugar are added to and mixed with the first interim mixture, to form a second interim mixture, and wherein the spiced rum is added to and mixed with the second interim mixture to form the food condiment.

6. The food condiment of claim 5, further comprising at least one spice.

7. The food condiment of claim 6, wherein a spice of the at least one spice is Cajun spice, and wherein the Cajun spice is added in an amount of about one tablespoon and one-fourth teaspoon to a mixture of the spiced rum and the second interim mixture to form the food condiment.

8. The food condiment of claim 7, wherein the Cajun spice comprises:
about half tablespoon of sweet paprika;
about two tablespoons of kosher salt;
about two tablespoons of garlic powder;
about one tablespoon of dried thyme;
about two teaspoons of ground celery seeds;
about two teaspoons of ground black pepper; and
about two teaspoons of cayenne pepper.

9. The food condiment of claim 6, wherein a spice of the at least one spice is Jamaican spice, and wherein the Jamaican spice is added in an amount of about one tablespoon and one teaspoon to a mixture of the spiced rum and the second interim mixture to form the food condiment.

10. The food condiment of claim 9, wherein the Jamaican spice comprises:
about one-fourth cup of brown sugar;
about three tablespoons of kosher salt;
about three tablespoons of ground coriander;
about two tablespoons of ground ginger;
about two tablespoons of garlic powder;
about one tablespoon of ground allspice;
about one tablespoon of ground black pepper;
about two teaspoons of cayenne pepper;
about two teaspoons of ground nutmeg; and
about one and a half teaspoons of ground cinnamon.

11. A method for preparing a food condiment, the method comprising:
mixing about one cup of yellow mustard, about two and one-third cups of a salad dressing, and about one-fourth cup of sour cream to form a first interim mixture;
adding about one-third cup of clover honey, about one-eighth cup of dark amber maple syrup, and about three tablespoons of light brown sugar to the first interim mixture;
mixing the clover honey, the dark amber maple syrup, and the light brown sugar with the first interim mixture until the light brown sugar dissolves, to form a second interim mixture;
adding about one and a half tablespoons of spiced rum to the second interim mixture; and
mixing the spiced rum and the second interim mixture for about two minutes to form the food condiment.

12. The method of claim 11, further comprising adding about one tablespoon and one-fourth teaspoon of Cajun spice to a mixture of the spiced rum and the second interim mixture.

13. The method of claim 12, wherein the Cajun spice comprises about half tablespoon of sweet paprika, about two tablespoons of kosher salt, about two tablespoons of garlic powder, about one tablespoon of dried thyme, about two teaspoons of ground celery seeds, about two teaspoons of ground black pepper, and about two teaspoons of cayenne pepper.

14. The method of claim 11, further comprising adding one tablespoon and one teaspoon of Jamaican spice to a mixture of the spiced rum and the second interim mixture.

15. The method of claim 14, wherein the Jamaican spice comprises about one-fourth cup of brown sugar, about three tablespoons of kosher salt, about three tablespoons of ground coriander, about two tablespoons of ground ginger, about two tablespoons of garlic powder, about one tablespoon of ground allspice, about one tablespoon of ground black pepper, about two teaspoons of cayenne pepper, about two teaspoons of ground nutmeg; and about one and a half teaspoons of ground cinnamon.
